(19) United States
(12) Patent Application Publication
(10) Pub. No.: US 2015/0264707 A1
(43) Pub. Date: Sep. 17, 2015

(54) Uplink Backpressure Coordination

(71) Applicant: NOKIA SOLUTIONS AND NETWORKS OY, Espoo (FI)

(72) Inventors: Ralf Golderer, Leinfelden-Echterdingen (DE); Hans Kroener, Ulm (DE)

(21) Appl. No.: 14/438,492

(22) PCT Filed: Oct. 26, 2012
(86) PCT No.: PCT/EP2012/071247

§ 371 Date: Apr. 24, 2015

(51) Int. Cl. H04W 72/12; H04W 28/02; H04W 72/08

(52) U.S. Cl. CPC H04W 72/1284; H04W 72/087; H04W 28/0205; H04W 28/0268; H04W 88/08

(57) ABSTRACT

The present invention addresses apparatuses, methods and computer program product for enabling uplink backpressure coordination in networks. Uplink user data rate on a transmission interface of a base station as well as uplink user data rate for each radio cell assigned to the base station per quality of service class identifier class based on each active data radio bearer are evaluated, available transmission resources of the transmission interface based on the evaluation results are determined, transmission resources to each guaranteed bit rate bearer are assigned, and the remaining transmission resources to the active non-guaranteed bit rate bearers are distributed.

### FIELD OF THE INVENTION

The present invention generally relates to wired or wireless communication networks, and more specifically relates to a method, apparatus and computer program product for enabling improved uplink backpressure coordination in networks.

### BACKGROUND

Long Term Evolution (LTE) introduces a new air interface which provides much higher throughput and requests for lower latency which ends up in greatly improved system capacity than those of former radio access network RAN systems. The improvements at the air interface lead to increased expectations on the end-user quality for services over LTE as compared to existing 2G/3G networks which impact the requested capacity at the transport network as well. In detail the transport network has to cope with:
Highly varying data load of bursty character coming from the huge volume non guaranteed bit rate non-GBR traffic; and
Higher expectations on the responsiveness of interactive applications and voice services which increase the demand on lower packet delay in the transport network.

In contrast to these improvements of the LTE air interface the transport network is in significant number of cases still the limiting factor because the transport network can't provide the capacity to satisfy all the needs coming from the improved air interface. Especially, in cases the base stations are connected via leased lines with the backbone towards the core network (for user data this is the serving gateway S-GW) the operators are anxious for clipping the operational expenditure OPEX. This leads not only in some installations to transport networks with limited transfer capacity which ends up in the waste of the spectral efficiency gain coming from LTE.

So basically in an LTE network there can be congestion on the radio interface or on the transport network (especially on the so-called last mile transport that connects the LTE base station (eNode B) with the transport network).

FIG. 1 shows a basic LTE Network topology. The LTE end user 16 communicates with the LTE base station (eNode B) 14 via the radio interface 18. One eNode B 14 serves normally several radio cells 15a to 15k, and one radio cell serves typically several LTE users 16a to 16p. The allocation of the radio resources in one radio cell to the different LTE users is handled by the radio interface scheduler. The eNode B 14 is connected to the LTE core network 11 via the so-called transport network 17 which is composed of the last mile transport link 13 and the transport aggregation network 12 which concentrates the traffic from many eNode Bs towards the core network 11. At the access to the transport network there is a transport scheduler that controls the access to the so-called last mile transport 13. Both the radio interface schedulers and the UL transport scheduler are located in the eNode B 14.

Furthermore, the end to end service can be broken down to different bearers, which is shown in FIG. 2. The service over the radio interface and over the S1 interface is basically defined by the radio and the S1 bearer service. Different bearers are established for different quality of service QoS classes.

In today's installations the radio interface schedulers and the transport interface scheduler independently control the data flow over the corresponding interfaces. Limited transport network capacity or limited radio interface capacity leads in the first stage to a higher delay in the data transmission. After a certain period of time the congestion is pending the delay passes over to data loss as since the arriving data rate exceeds the forwarding data rate which leads to buffer overflows. In consequence higher layers like e.g. transmission control protocol TCP which is controlling file transfer protocol FTP services have to initiate the required retransmissions which lead to higher latency for the FTP services. Services which are not protected by a transmission control protocol are disturbed by data loss and impact the quality of these services negatively in a large scale. E.g., the quality of voice over LTE VoLTE services decreases with increasing packet loss and may lead to interruptions of the speech so that the conversation can't be kept as usual.

Therefore, additional QoS mechanisms have been introduced at the radio interfaces as well as in the transport networks for service differentiation. The QoS handling in LTE is based on the 3GPP concept on the QCI (Quality of service Class Identifier) that is provided by the core network for each radio bearer. So far 9 different QCI classes have been defined in 3GPP TS23.203 with different requirements concerning traffic type (guaranteed bit rate/non-guaranteed bit rate GBR/non-GBR, priority, packet delay budget and packet loss rate), as indicated in FIG. 3. In addition for a GBR bearer a certain guaranteed bit rate is provided by the core network at bearer setup.

FIG. 3 shows the QCI definition from 3GPP TS23.203, wherein the following notes apply to respective items.

NOTE 1: A delay of 20 ms for the delay between a policy and charging enforcement function PCEF and a radio base station should be subtracted from a given packet delay budget PDB to derive the packet delay budget that applies to the radio interface. This delay is the average between the case where the PCEF is located “close” to the radio base station (roughly 10 ms) and the case where the PCEF is located “far” from the radio base station, e.g. in case of roaming with home routed traffic (the one-way packet delay between Europe and the US west coast is roughly 50 ms). The average takes into account that roaming is a less typical scenario. It is expected that subtracting this average delay of 20 ms from a given PDB will lead to desired end-to-end performance in most typical cases. Also, note that the PDB defines an upper bound. Actual packet delays—in particular for GBR traffic—should typically be lower than the PDB specified for a QCI as long as the user equipment UE has sufficient radio channel quality.

NOTE 2: The rate of non congestion related packet losses that may occur between a radio base station and a PCEF should be regarded to be negligible. A PELR value specified for a standardized QCI therefore applies completely to the radio interface between a UE and radio base station.

NOTE 3: This QCI is typically associated with an operator controlled service, i.e., a service where the service data flow SDF aggregate's uplink/downlink packet filters are known at the point in time when the SDF aggregate is authorized. In case of E-UTRAN this is the point in time when a corresponding dedicated evolved packet system EPS bearer is established/modified.

NOTE 4: If the network supports Multimedia Priority Services (MPS) then this QCI could be used for the prioritization of non real-time data (i.e. most typically TCP-based services/applications) of MPS subscribers.

NOTE 5: This QCI could be used for a dedicated “premium bearer” (e.g. associated with premium content) for any subscriber/subscriber group. Also in this case, the SDF aggregate's uplink/downlink packet filters are known at the point in time when the SDF aggregate is authorized. Alternatively, this QCI could be used for the default bearer of a user equipment/packet data network UE/PDN for “premium subscribers”.

NOTE 6: This QCI is typically used for the default bearer of a UE/PDN for non privileged subscribers. Note that aggregated maximum bit rate AMBR can be used as a “tool” to provide subscriber differentiation between subscriber groups connected to the same PDN with the same QCI on the default bearer.

Generally, LTE is based on IP based transport networks. The IP based transport network may use the so-called DiffServ concept for service differentiation that classifies the IP packets according to their QoS requirements and assign different DiffServ Code Points (DSCP). In addition there are certain traffic forwarding principles defined (so-called Per Hop Behaviour=PHB) according to which a certain class of traffic should be served. The transport scheduler uses different buffers for the different classes of IP packets and serves those such that the corresponding PHB of the corresponding IP traffic class can be satisfied. First of all, for real time traffic like voice over LTE or video streaming should get a guaranteed bit rate and delay by taking priority over non real time traffic (usually handled by Expedited Forwarding=EF PHB). The non GBR service differentiation over the transport interface is normally handled via the so-called Assured Forwarding=AF PHB which is further subdivided into different subclasses according to delivery priority and drop precedence. Normally a weighted fair queuing scheme is used for the AF PHBs where different weights are applied for the different AF classes. The weighted fair queuing at the transport interface assigns to each of the non GBR traffic classes a share of the transport capacity that is left over from guaranteed bit rate/EF traffic in proportion to its weight. This weight is statically assigned and does not scale with the number of bearers that are assigned to a certain DiffServ class. Best effort BE is used for the lowest priority.

FIG. 4 provides an overview on an example mapping between QCIs and transport PHBs. In particular, FIG. 4 shows an example mapping between QCI, DSCP and PHB.

The scheduling principles at the radio interface could be as follows:
GBR bearers are scheduled according to its guaranteed bit rate and packet delay budget;
Non-GBR bearers have no defined data rate and might be scheduled according to a scheduling weight that is assigned to the corresponding CQI as well as according to the current radio conditions that the corresponding UE experiences (so called weighted proportional fair scheduling); and
Scheduling is performed on a per bearer/UE basis, i.e., the share of resources that is assigned to a certain QCI scales with the number of bearers that are established for this QCI.

Today's transport and radio interface schedulers act independently from each other.

The drawback of this solution is that there occur situations where data are successfully transmitted over the uplink radio interface which are later on dropped at the eNode B in case of transport congestion. This causes unnecessary uplink interference to neighbour cells. In addition, these unnecessary transmissions reduce the battery life time of the user equipment UE.

Another more severe drawback is that there is no consistency between the transport and the radio interface QoS handling since the transport interface uses a fix share between non GBR CQIs, because the transport network is not aware of individual radio interface connections, whereas the radio interface scales the share with the number of bearers that are setup for the corresponding QCI. In addition, the radio interface could apply a proportional fair scheduling (offering fair allocation of resources) that provides a throughput gain compared to a fair scheduling (offering fair allocation of throughputs). Thus the QoS and allocation concepts at the radio interface are more advanced than the QoS concepts at the transport interface. In particular the handling at the radio interface is compliant to the 3GPP QCI concept whereas the DiffServ concept is not fully in line with the 3GPP requirements (mainly since the IP transport network QoS concepts have been defined before 3GPP was even in place).

The problem becomes evident from a simple example: Let us assume a simple example with 2 non GBR traffic classes, a high priority non GBR QCI having a scheduling weight of 10 and a low priority traffic class having a scheduling weight of 1, respectively. Furthermore, there is just one radio cell at the eNode B and all UEs have just one bearer and experience the same radio propagation conditions. This would mean that at the transport interface all bearers with high priority QCI receive in sum ten times the data rate of the low priority QCIs whereas at the radio interface each high priority bearer gets 10 times the data rate of the low priority bearer. Thus if there are 10 bearers with the high priority QCI established and if there is just one bearer with low priority QCI then all bearers would get the same data rate at the transport interface, whereas at the radio interface it is still so that the high QCI priority bearers get still 10 times the data rate of the low priority QCI bearer.

### SUMMARY OF THE INVENTION

Therefore, in order to overcome the drawbacks of the prior art, it is an object underlying the present invention to provide an uplink backpressure coordination optimization. In particular, it is an object of the present invention to provide a method, apparatus and computer program product for enabling uplink backpressure coordination in communication networks, such as in LTE networks.

According to a first aspect of the present invention, there is provided a method, comprising evaluating an uplink user data rate on a transmission interface of a base station in an LTE network, evaluating an uplink user data rate for each radio cell assigned to the base station per quality of service class identifier class based on each active data radio bearer, determining available transmission resources of the transmission interface based on the evaluation results, assigning transmission resources to each guaranteed bit rate bearer, and distributing the remaining transmission resources to the active non-guaranteed bit rate bearers.

According to a second aspect of the present invention, there is provided an apparatus, which comprises a processing means adapted to evaluate an uplink user data rate on a transmission interface of a base station in an LTE network and to evaluate an uplink user data rate for each radio cell assigned to the base station per quality of service class identifier class based on each active data radio bearer, a determination means adapted to determine available transmission resources of the transmission interface based on the evaluation results, an assigning means adapted to assign transmission resources to each guaranteed bit rate bearer, and a distribution means adapted to distribute the remaining transmission resources to the active non-guaranteed bit rate bearers.

According to a third aspect of the present invention, there is provided a computer program product comprising computer-executable components which, when the program is run, are configured to carry out the method according to the first aspect.

According to further embodiments of the present invention, distributing the remaining transmission resources is performed according to a preset radio interface scheduling principle. Thereby, according to certain embodiments, the preset radio interface scheduling principle may be distributing the remaining transmission resources for the radio cells in proportion to the overall quality of service class identifier weights of active non-guaranteed bit rate bearers and in proportion to the radio channel of the involved user equipments in the corresponding radio cells.

According to further embodiments, the transmission interface consists of a radio interface and a transport network interface for the base station.

According to further embodiments, assigning transmission resources is carried out in case the throughput resources of at least one of the radio cells does not satisfy the need of non-guaranteed bit rate bearer traffic in the other radio cells.

According to certain embodiments, the excess bandwidth of underloaded radio cells is re-distributed to the radio cells with too low bandwidth resources in proportion to the evaluated quality of service class identifier weights of all active non-guaranteed bit rate bearers in those cells.

According to further embodiments, assigning transmission resources to each guaranteed bit rate bearer is performed by at least one of an uplink radio scheduler and a transport interface scheduler.

According to other embodiments of the invention, assigning transmission resources to each guaranteed bit rate bearer is performed so as to assure the quality of service related to these guaranteed bit rate bearers.

Advantageous further developments or modifications of the aforementioned exemplary aspects of the present invention are set out in the dependent claims.

### BRIEF DESCRIPTION OF DRAWINGS

For a more complete understanding of example embodiments of the present invention, reference is now made to the following descriptions taken in connection with the accompanying drawings in which:

FIG. 1 shows a basic LTE Network topology;

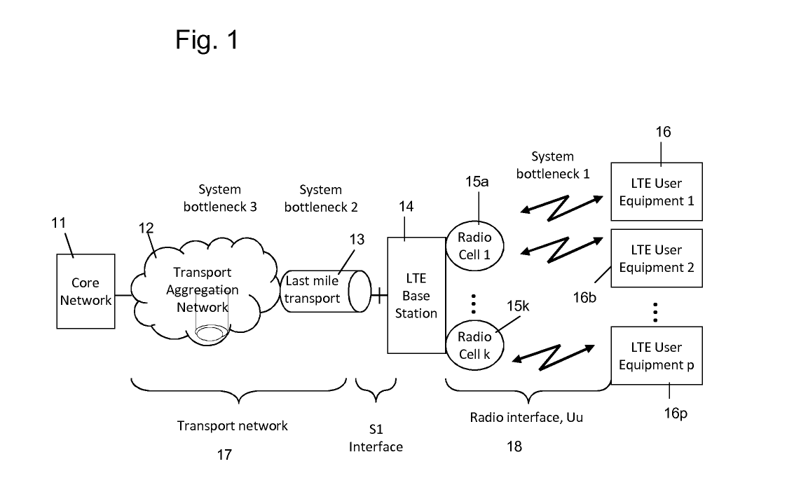

FIG. 2 shows an overview on QoS and bearer service concepts in LTE;

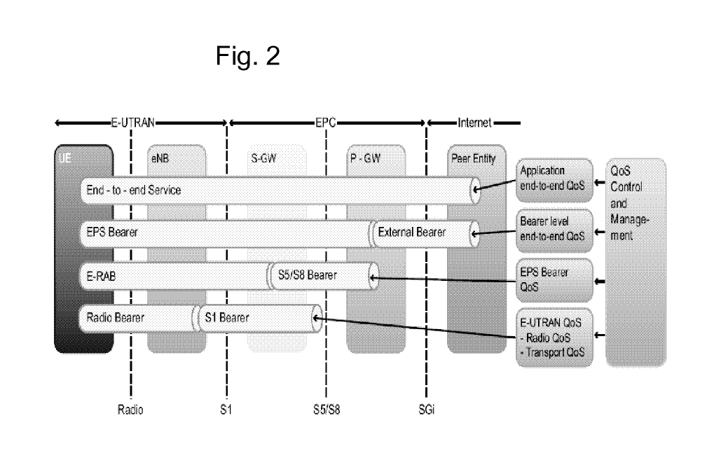

FIG. 3 shows the QCI definition from 3GPP TS23.203;

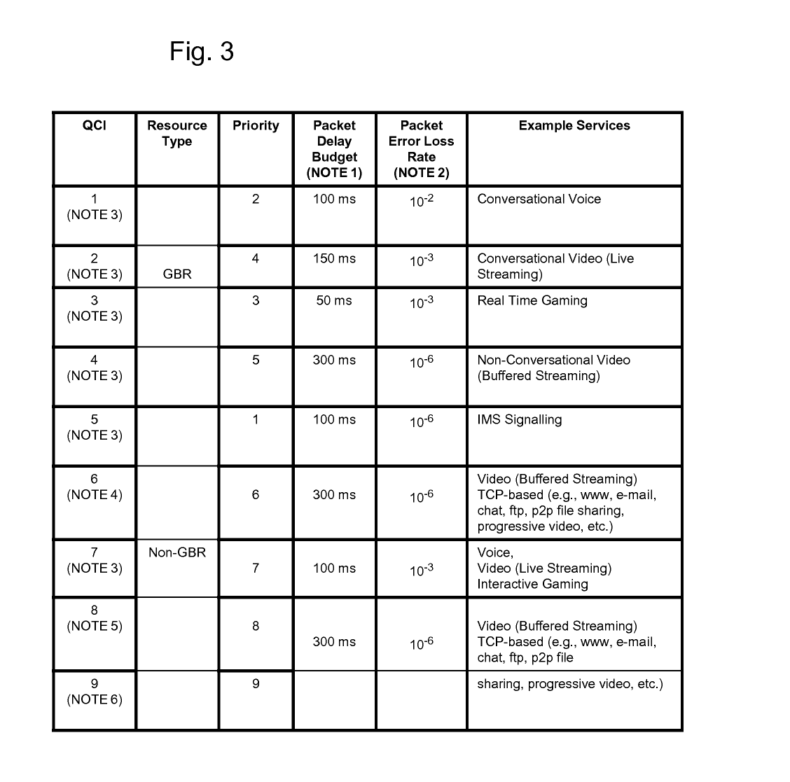

FIG. 4 shows an example mapping between QCI, DSCP and PHB;

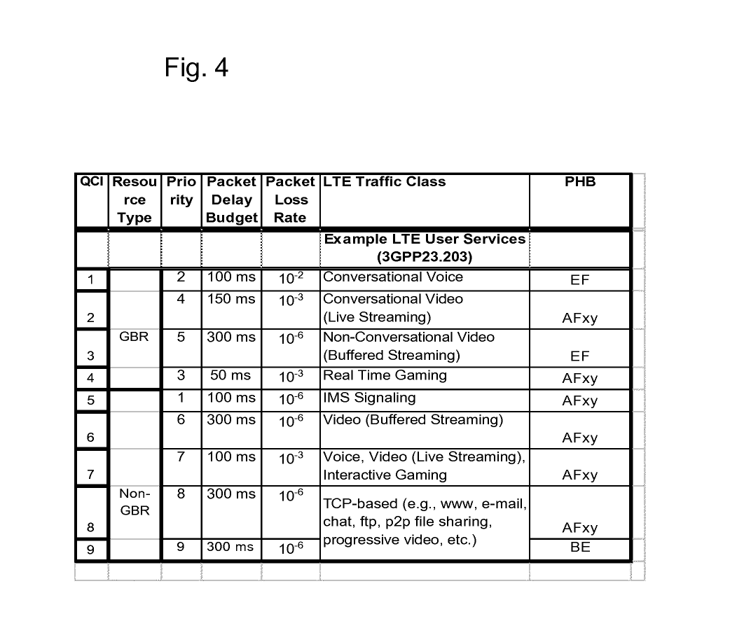

FIG. 5 shows a principle configuration of an example for a method according to certain embodiments of the present invention;

FIG. 6 shows a principle architecture of an example for an apparatus according to certain embodiments of the present invention; and

FIG. 7 shows the architecture of the UL Backpressure Coordination according to certain embodiments of the present invention.

### DESCRIPTION OF EXEMPLARY EMBODIMENTS

Exemplary aspects of the present invention will be described herein below. More specifically, exemplary aspects of the present invention are described hereinafter with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. As such, the description of exemplary embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein.

Hereinafter, various embodiments and implementations of the present invention and its aspects or embodiments are described using several alternatives. It is generally noted that, according to certain needs and constraints, all of the described alternatives may be provided alone or in any conceivable combination (also including combinations of individual features of the various alternatives).

Basically, according to certain embodiments, the present invention specifies a novel congestion control scheme for LTE networks in uplink. The proposed method according to certain embodiments works based on the coordination between the load situation on the transport network and the traffic volume coming from the air interface which is characterized by time varying load situations. The invention may be located in a base station where two network interfaces can be monitored and where the required control entity is implemented in order to efficiently minimize the congestion situation in the transport network.

In particular, according to certain embodiments, the present invention specifies a method which controls the data transmission in uplink UL via the radio cells in response to the available transfer capacity on the transport interface, the utilization of the radio cells itself as well as QoS aspects of the data radio bearers of all involved radio cells. Basically, when there is a congestion in the last mile of the uplink transport network, a smart backpressure mechanism will do a QoS aware backpressure towards the radio interface schedulers such that those throttle the UE traffic in a QoS aware manner, such that the total traffic that is generated by the UEs in all radio cells is tailored to the transport capacity of the last mile transport. Therefore, the capacity bottleneck at the transport network access will be removed and the radio interface mechanisms will dominate the QoS handling.

For that purpose, the uplink user data rate is evaluated on the transport interface of the eNode B as well as for the radio cells separately per QCI class (for the GBR bearers and the different types of non-GBR bearers), respectively. Only active data radio bearers are taken into account for the evaluation, which means that user data have to be available in the UE transmission buffer. Transmission resources for the GBR bearer shall be guaranteed by the UL radio and transport interface schedulers such that the QoS which is related to these GBR bearers can be guaranteed. So the radio interface and the transport interface schedulers need to prioritize GBR traffics such that the guaranteed bit rate as well as the delay budget is respected. The remaining uplink transport network capacity at the access to the last mile is distributed to the radio cells in proportion to the overall QCI weights of the active non-GBR bearers and in proportion to the quality of the radio channel of the involved UEs in the corresponding radio cells. The re-assignment of the scarce throughput resources is executed in case at least one of the cells has got excessive transmission resources whereas the assigned throughput resources can't satisfy the needs of the non-GBR traffic in the other cells. For this case the excess bandwidth is re-distributed to the radio cells with too low bandwidth resources in proportion to the primarily evaluated QCI weight of all active non-GBR bearers in those cells.

This scheme controls the radio interface scheduling such that there are no unnecessary uplink transmissions over the radio network in case there is congestion in the last mile transport. This avoids packet discards in front of the transport interface and reduces the uplink interference in the system.

Furthermore, there is now an aligned QoS handling according to the 3GPP requirements for the uplink scheduling for the last mile transport and the radio interfaces since the distribution of the transport capacity that is available for non-GBR traffic is done according to the scheduling principles that are used at the radio interface. In other words, the transport and the radio interface have a common and consistent QoS handling which is aligned to the 3GPP principles, i.e., the QoS scales on a per bearer basis and takes in addition the radio interface situation into account.

The same principles can be used with different non-GBR scheduling strategies at the radio interface as long as the re-distribution of the total non-GBR transport capacity is done according to the scheduling scheme that is used at the radio interface. So the redistribution scheme of the transport resources to the radio cells needs to be done in alignment to the radio interface scheduling schemes.

Since the uplink traffic flowing from all radio schedulers do not overload the last mile transport, there is no need to apply complex transport scheduling principles at the access to the last mile transport line. So, basically a simple priority scheduler can be used that gives priority to the GBR traffic whereas non-GBR traffic can be handled in a first come first serve manner. Of course also more complex scheduling schemes could be used but there is no real need to do so.

On the other hand, there is still a need to sort the traffic of different QCIs into different DiffServ traffic classes in order to have a QoS aware congestion handling in the transport aggregation network. However, aggregation network congestion can just keep the quality of GBR transmissions whereas it is not possible to fully align the non-GBR traffic handling with the principles applied at the radio interface. However, since in the aggregation network serves the traffic of many radio cells, the traffic needs per QCI class are rather stable (traffic demands of many bearers and radio conditions of many UEs simply average out).

Therefore a static assignment of the scheduling weights for different PHBs seems to be sufficient to cover the rare cases where transport aggregation network congestion occurs.

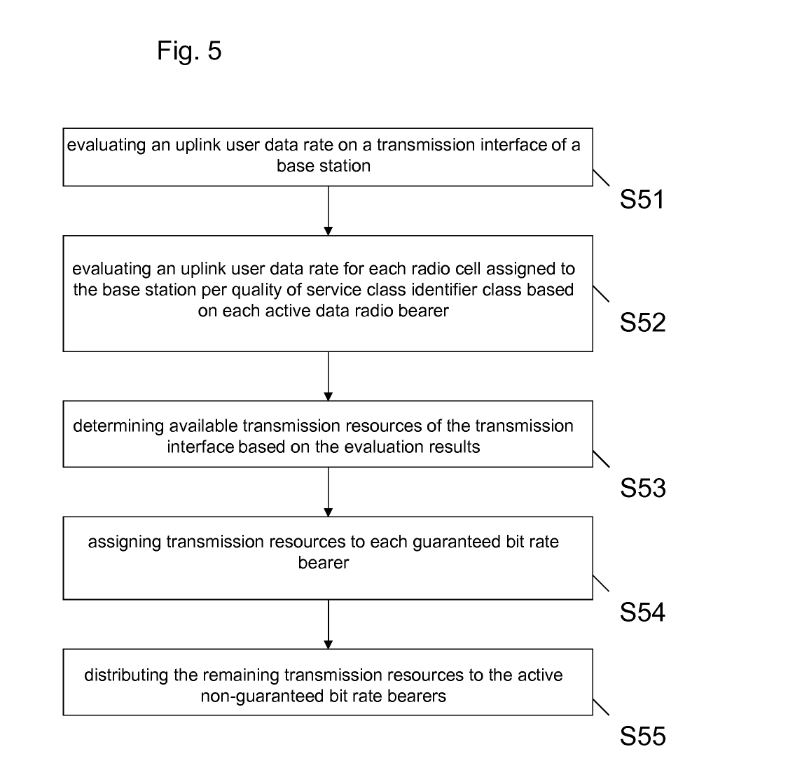

FIG. 5 shows a principle flowchart of an example for a method according to certain embodiments of the present invention.

In Step S51, an uplink user data rate on a transmission interface of a base station in an LTE network is evaluated.

In Step S52, an uplink user data rate for each radio cell assigned to the base station per quality of service class identifier class based on each active data radio bearer are evaluated.

In Step S53, available transmission resources of the transmission interface based on the evaluation results are determined.

In Step S54, transmission resources to each guaranteed bit rate bearer are assigned.

In Step S55, the remaining transmission resources to the active non-guaranteed bit rate bearers are distributed.

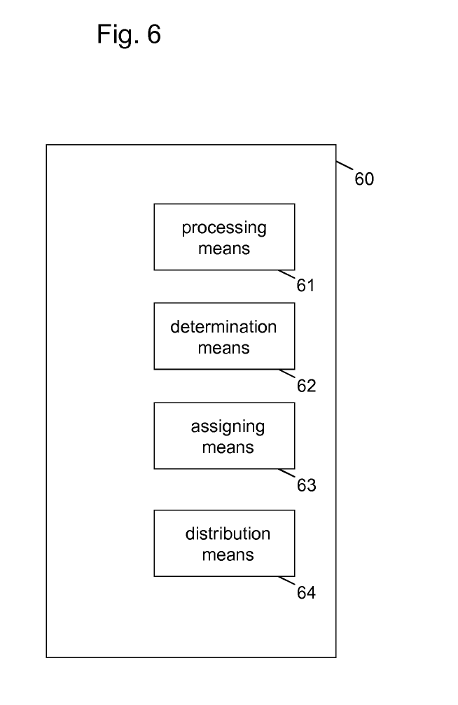

FIG. 6 shows a principle configuration of an example for an apparatus according to certain embodiments of the present invention. The apparatus 60 comprises a processing means 61 adapted to evaluate an uplink user data rate on a transmission interface of a base station in an LTE network and to evaluate an uplink user data rate for each radio cell assigned to the base station per quality of service class identifier class based on each active data radio bearer, a determination means 62 adapted to determine available transmission resources of the transmission interface based on the evaluation results, an assigning means 63 adapted to assign transmission resources to each guaranteed bit rate bearer, and distribution means 64 adapted to distribute the remaining transmission resources to the active non-guaranteed bit rate bearers.

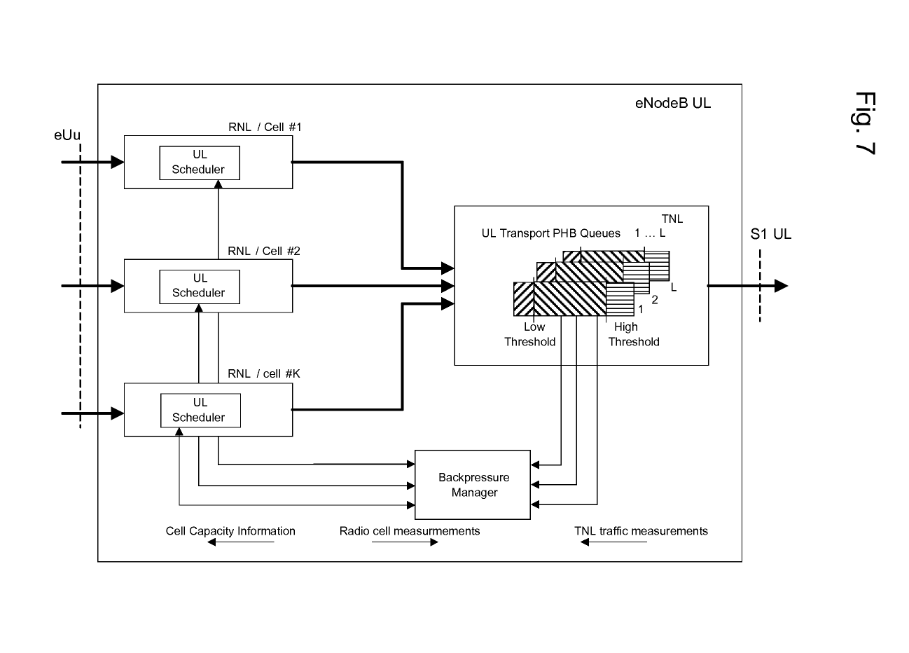

The basic system architecture of the implementation is illustrated in FIG. 7.

According to certain embodiments of the present invention, in general, the system works as follows:
UL radio interface scheduling is done by UL schedulers 1, 2, . . . , K; buffering of UL data is in the UE;
UL transport scheduler handles access to the transport networks and serves the traffic from the different PHB queues 1, 2, . . . , L;
Backpressure manager is a logical entity which collects measurements from transport and radio interface schedulers, runs the backpressure algorithm and provides the capacity limits to the radio interface schedulers (this entity can be physically integrated into one of the schedulers);
The UL transport scheduler performs UL transport throughput and buffer filling measurements on a per PHB (or per QCI) and provides those to the backpressure manager;
UL radio interface schedulers perform traffic and buffer filling measurements on per UE and per non-GBR bearer basis and delivers those to the backpressure manager; and
The backpressure manager runs the backpressure algorithm and provides the capacity limits to the radio interface schedulers.

In the following, an example algorithm for performing the QoS aware backpressure scheme is described. Basically, the transport throughput will be measured per PHB. Basically it is assumed that the radio interface schedulers work according to a weighted proportional fair scheduling scheme where a non-GBR bearer j of UE i in cell k should get a certain scheduling weight w_{k,i,j}=wₘ if the bearer is of type QCI m. In addition the rate that the UE i could achieve at the radio interface according to the current propagation conditions (or channel quality) is denoted by R_{k,i}, wherein R_{k,i} can be measured over the whole LTE bandwidth or over a certain number of physical resource blocks. Therefore, if the non-GBR bearer j of UE i in cell k is active at a certain point in time it should receive a rate r_{k,i,j,non-GBR} that is in proportion to the weight w_{k,i,j} as well as to the channel rate R_{k,i}:

r_{k,i,j,non-GBR}∝w_{k,i,j}·R_{k,i} (1).

Therefore, the total data rate of all the active non-GBR bearers from cell k should be in proportion to a rate r_{k,non}_{_{—}}_{GBR} which is defined as:

$${r}_{k , non \text{-} GBR} = {\sum }_{i} {\sum }_{j ∈ active non \text{-} GBR bearers} {w}_{k , i , j} \cdot {R}_{k , i} . \qquad ( 2 )$$

This rate share r_{k,non-GBR} is calculated by the radio interface scheduler of cell k every x ms and is given to the backpressure manager.

On the other hand the transport interface scheduler calculates the transport capacity t_{non-GBR} that is available for all non-GBR traffic as difference between the total transport capacity Cₜ and the measured data rates of the GBR PHB classes, where t_{I,GBR} denotes the data rate of GBR PHB class I.

$${C}_{t , non \text{-} GBR} = {C}_{t} - {\sum }_{l ∈ GBR PHB} {t}_{l , GBR} . \qquad ( 3 )$$

The transport interface scheduler calculates this value every x ms and provides the value to the backpressure manager.

The backpressure manager calculates the non-GBR scheduling capacity limit C_{k,non-GBR} of radio cell k from the rate share of the cell k and the available non-GBR transport capacity including a safety margin Δ_{SM} and an overhead correction factor OCF that takes account of the different packet overheads at the transport and the radio interfaces due to different protocol stacks:

$${C}_{k , non \text{-} GBR} = \frac{{r}_{k , non \text{-} GBR}}{{\sum }_{n = 1}^{K} {r}_{n , non \text{-} GBR}} \cdot {C}_{t , non \text{-} GBR} \cdot {Δ}_{SM} \cdot O C F . \qquad ( 4 )$$

If one or several radio cells are not able to reach its non-GBR scheduling capacity limit C_{k,non-GBR} since the non-GBR UEs in this cell do not deliver enough data then the spare non-GBR capacity shall be re-distributed in proportion to the shares from equation (2) to the remaining radio cells k until all transport capacity is used (in case of transport congestion it is always so that the radio interface could deliver more data than the transport interface can handle).

The radio interface scheduler for cell k will stop scheduling of non-GBR traffic when the limit C_{k,non-GBR} is reached (this limit can be applied on a per TTI basis or it might be averaged over a certain time). This limit does not take into account any hybrid ARQ retransmissions (since only correctly delivered data are send to the core network).

In the following we will describe some implementation options:
If the radio interface scheduler will work according to a weighted fair share then equation (2) is replaced by

$${r}_{k , non \text{-} GBR} = {\sum }_{i} {\sum }_{j ∈ active non \text{-} GBR bearers} {w}_{k , i , j} \cdot R , \qquad ( 5 )$$

where R is a constant rate.
The backpressure can work continuously as described above or it might just be invoked when there is a transport congestion state detected. The buffer utilization at the transport network interface is measured per PHB and indicated by two states—a congestion and a no congestion state. Only the PHB queues which serve non-GBR traffic have to be monitored. Congestion in the TNL is detected in case the utilization in any of the PHB queues exceeds an upper threshold. The TNL congestion indication is cleared immediately when the utilization in the PHB queue which triggered the congestion falls below the lower threshold. Ping-pong effects in the indication of the congestion are prevented by the two threshold approach. This is illustrated in FIG. 7.
The overhead correction factor OCF might be statically assigned via operation and maintenance or the packet size overheads might be directly measured in the radio interface or transport interface schedulers, respectively.
The safety margin Δ_{SM} can be assigned statically to a value less than 1 in case there is a differentiation between a congestion and a non congestion state depending on the transport buffer state. This is due to the fact that in this scheme the backpressure is only activated in an overload state and therefore the air interface flow should be throttled to reduce the buffer sizes at the transport scheduler to avoid packet loss.
If there is a continuous backpressure it is useful to choose the safety margin Δ_{SM} as a function of the buffer status of the transport queues. For high buffer filling levels the Δ_{SM} should be lower than 1 to throttle the radio interface and reduce the buffer filling levels at the transport queue. On the other hand a value Δ_{SM}>1 should be chosen if the transport buffers run empty in order to enhance the traffic from the radio interface. By this the transport and radio interface throughput could be balanced.

The main advantages of the proposed scheme are the following:
Balancing of uplink radio interface and transport interface throughput in case of transport congestion
Avoidance of packet discarding in the eNode B in case of transport congestion
Avoidance of unnecessary uplink interference which improves the system throughput of the neighbour radio cells
Consistent QOS handling at radio interface and transport interface
Per bearer QoS handling instead of per traffic class handling allows a scaling of the throughput in accordance to the number of bearers that are established for the different QoS classes
QoS handling is in line with the 3GPP principles
Changes are kept local and do not require changes in the radio or transport interface protocols

In the foregoing exemplary description of the apparatus, only the units that are relevant for understanding the principles of the invention have been described using functional blocks. The apparatuses may comprise further units that are necessary for its respective function. However, a description of these units is omitted in this specification. The arrangement of the functional blocks of the apparatuses is not construed to limit the invention, and the functions may be performed by one block or further split into sub-blocks.

According to exemplarily embodiments of the present invention, a system may comprise any conceivable combination of the thus depicted devices/apparatuses and other network elements, which are arranged to cooperate as described above.

Embodiments of the present invention may be implemented as circuitry, in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a base station, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The present invention relates in particular but without limitation to mobile communications, for example to environments under LTE, and can advantageously be implemented also in controllers being part of base stations or being connectable to such base station. That is, it can be implemented e.g. as/in chipsets to connected devices.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following meanings for the abbreviations used in this specification apply:
DSCP DiffServ Code Point
BE best effort
eNB evolved Node B
EPC Evolved Packet Core
FTP File Transfer Protocol
GBR Guaranteed Bit Rate
IP Internet Protocol
LTE Long Term Evolution
non-GBR non Guaranteed Bit Rate
OPEX OPerational EXpenditure
PHB Per Hop Behavior
QCI QoS Class Identifier
QoS Quality of Service
RAN Radio Access Network
RNL Radio Network Layer
S1 S1 Interface between eNB and EPC
TCP Transmission Control Protocol
TNL Transport Network Layer
UE User Equipment
UL UpLink
VoLTE Voice over Long Term Evolution
2G 2^{nd} generation mobile network (GSM)
3G 3^{rd} generation mobile network (UMTS)

1. A method, comprising:
evaluating an uplink user data rate on a transmission interface of a base station in an LTE network;
evaluating an uplink user data rate for each radio cell assigned to the base station per quality of service class identifier class based on each active data radio bearer;
determining available transmission resources of the transmission interface based on the evaluation results;
assigning transmission resources to each guaranteed bit rate bearer; and
distributing the remaining transmission resources to the active non-guaranteed bit rate bearers.

2. The method according to claim 1, wherein distributing the remaining transmission resources is performed according to a preset radio interface scheduling principle.

3. The method according to claim 2, wherein the preset radio interface scheduling principle is distributing the remaining transmission resources for the radio cells in proportion to the overall quality of service class identifier weights of active non-guaranteed bit rate bearers and in proportion to the radio channel quality of the involved user equipments in the corresponding radio cells.

4. The method according to claim 1, wherein the transmission interface consists of a radio interface and a transport network interface for the base station.

5. The method according to claim 1, wherein assigning transmission resources is carried out in case the throughput resources of at least one of the radio cells does not satisfy the need of non-guaranteed bit rate bearer traffic in the other radio cells.

6. The method according to claim 5, further comprising re-distributing the excess bandwidth of underloaded radio cells to the radio cells with too low bandwidth resources in proportion to the evaluated quality of service class identifier weights of all active non-guaranteed bit rate bearers in those cells.

7. The method according to claim 1, wherein assigning transmission resources to each guaranteed bit rate bearer is performed by at least one of an uplink radio scheduler and a transport interface scheduler.

8. The method according to claim 1, wherein assigning transmission resources to each guaranteed bit rate bearer is performed so as to assure the quality of service related to these guaranteed bit rate bearers.

9. An apparatus, comprising:
processing means adapted to evaluate an uplink user data rate on a transmission interface of a base station in an LTE network and to evaluate an uplink user data rate for each radio cell assigned to the base station per quality of service class identifier class based on each active data radio bearer;
determination means adapted to determine available transmission resources of the transmission interface based on the evaluation results;
assigning means adapted to assign transmission resources to each guaranteed bit rate bearer; and
distribution means adapted to distribute the remaining transmission resources to the active non-guaranteed bit rate bearers.

10. The apparatus according to claim 9, wherein the distribution means is further adapted to distribute the remaining transmission resources according to a preset radio interface scheduling principle.

11. The apparatus according to claim 10, wherein the preset radio interface scheduling principle is distributing the remaining transmission resources for the radio cells in proportion to the overall quality of service class identifier weights of active non-guaranteed bit rate bearers and in proportion to the radio channel quality of the involved user equipments in the corresponding radio cells.

12. The apparatus according to claim 9, wherein the transmission interface consists of a radio interface and a transport network interface for the base station.

13. The apparatus according to claim 9, wherein the assigning means is further adapted to assign transmission resources in case the throughput resources of at least one of the radio cells does not satisfy the need of non-guaranteed bit rate bearer traffic in the other radio cells.

14. The apparatus according to claim 13, further wherein the distribution means is further adapted to re-distribute the excess bandwidth of underloaded radio cells to the radio cells with too low bandwidth resources in proportion to the evaluated quality of service class identifier weights of all active non-guaranteed bit rate bearers in those cells.

15. The apparatus according to claim 9, wherein the assigning means is further adapted to assign transmission resources to each guaranteed bit rate bearer by at least one of an uplink radio scheduler and a transport interface scheduler.

16. The apparatus according to claim 9 wherein the assigning means is further adapted to assign transmission resources to each guaranteed bit rate bearer as to assure the quality of service related to these guaranteed bit rate bearers.

17. A computer program product comprising computer-executable components which, when the program is run, are configured to carry out the method according to claim 1.

18. The computer program product according to claim 17, wherein the computer program product comprises a computer-readable medium on which the software code is stored, or wherein the program is directly loadable into a memory of the processing device.
